(19) United States
(12) Patent Application Publication
(10) Pub. No.: US 2011/0185083 A1
(43) Pub. Date: Jul. 28, 2011

(54) IDENTIFIER AND LOCATOR STRUCTURE, AND COMMUNICATION METHOD BASED ON THE STRUCTURE

(75) Inventor: Heeyoung JUNG, Daejeon (KR)

(73) Assignee: Electronics and Telecommunications Research Institute, Daejeon (KR)

(21) Appl. No.: 13/015,211

(22) Filed: Jan. 27, 2011

(30) Foreign Application Priority Data
Jan. 27, 2010 (KR) 10-2010-0007473
Aug. 20, 2010 (KR) 10-2010-0080942
Jan. 26, 2011 (KR) 10-2011-0007829

(51) Int. Cl. G06F 15/16

(52) U.S. Cl. 709/238

(57) ABSTRACT

In an identifier and locator structure and a communication method based on the structure, only an identifier to identify a communication object is allocated to a mobile host, and a locator to indicate the location of the communication object is allocated to a corresponding end router. Accordingly, the mobile host and the end router communicate with each other on the basis of the identifier, and a source-side end router and a designation-side end router communicate with each other on the basis of the locator.

### CROSS-REFERENCE TO RELATED APPLICATION

This application claims priority to and the benefit of Korean Patent Application No. 10-2010-0007473, 10-2010-0080942, and 10-2011-0007829 filed in the Korean Intellectual Property Office on Jan. 27, 2010, Aug. 20, 2010, and Jan. 26, 2011, the entire contents of which are incorporated herein by reference.

### BACKGROUND OF THE INVENTION

(a) Field of the Invention

The present invention relates to an identifier and locator structure, and a communication method based on the structure.

(b) Description of the Related Art

A communication structure in a current Internet has an end-to-end structure in which an Internet protocol (IP) address (i.e., a basis for an identifier) is allocated to an end host, and communication between hosts is performed on the basis of the IP address.

In the communication structure of the Internet, an IP address is allocated to the interface of each host and a communication node. In a case where a sender is sought to transmit data to a destination, data including transmission information additionally includes a header containing control information. Here, the header includes an IP address of the source and an IP address of the destination.

Next, a data transmission method within a network uses routing path determination within a network on the basis of the destination IP address included in the header.

A data transmission method in a conventional Internet is designed by taking an Internet environment, consisting of a small number of fixed hosts, into consideration. The data transmission method can have the following inefficiency in a network environment based on a mobile environment consisting of billions or more mobile hosts.

First, in the current Internet in which a fixed environment is assumed, a locator (i.e., an IP address), indicating a location where a mobile host is placed, must be allocated to the corresponding mobile host. However, in a mobile environment, a method of allocating fixed location information to a mobile host having a varying locator value because the location of the mobile host can be changed has inefficiency, such as in reconfiguration of the locator, and the deterioration of communication performance.

Second, in the current Internet, an identifier to identify communication connectivity and locator information for actual data transmission are integrated into an IP address. This method may not be problematic in the fixed environment, but is not suitable for the mobile environment in which an identifier has to be fixed for service durability and a locator has to be often changed according to a moving location. Accordingly, this method requires an inefficient and additional procedure. Third, since an IP address corresponding to an identifier and a locator must be allocated to the interfaces of billions or more hosts, the problem of address exhaustion that can occur in the current IPv4 (Internet protocol ver. 4) can become worse. Further, a multi-homing technique in which one host is connected to a plurality of networks has recently been activated and thus the problem of address exhaustion can become worse.

Fourth, there is a problem in that data are inefficiently transmitted to a mobile host because of the above problems of the identifier structure. For example, in the case of a mobile IP (i.e., the most representative mobile environment support technique of the current Internet), inefficiency problems, such as tunneling, triangle routing, and an additional proxy operation, have been pointed out.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an identifier, a locator structure, and a communication method based on the structure having an advantage of efficient data transmission in a network environment consisting of mobile hosts.

An exemplary embodiment of the present invention provides a communication method between moving end hosts based on a structure in which only an identifier is allocated to the end host and a locator is allocated to an end router, the communication method including a first end router receiving transmission data from a source-side first end host, the first end router searching for a locator of a second end router corresponding to a destination-side second end host on the basis of only an identifier included in the transmission data, and the first end router sending the transmission data to the second end host via the second end router using the retrieved locator.

Another exemplary embodiment of the present invention provides an identifier and locator structure, wherein only an identifier to identify a communication object is allocated to a mobile host, and a locator to indicate a location of the communication object is allocated to a corresponding end router.

### BRIEF DESCRIPTION OF THE DRAWINGS

FIG. 1 is a diagram schematically showing Internet communication environment and an identifier structure according to an exemplary embodiment of the present invention,

FIG. 2 is an example of showing a communication environment based on the identifier structure according to an exemplary embodiment of the present invention, and

FIG. 3 is a diagram showing a communication method based on the identifier structure according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, unless explicitly described to the contrary, the word “comprise” and variations such as “comprises” or “comprising” will be understood to imply the inclusion of stated elements but not the exclusion of any other elements.

Hereinafter, an identifier and locator structure and a communication method based on the structure according to exemplary embodiments of the present invention are described in detail with reference to the accompanying drawings.

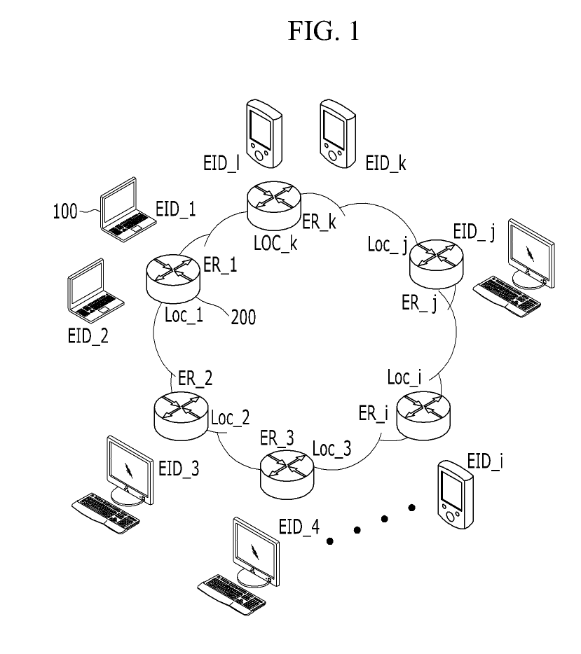

FIG. 1 is a diagram schematically showing Internet communication environment and an identifier structure according to an exemplary embodiment of the present invention.

First, in the Internet communication environment according to an exemplary embodiment of the present invention, an Internet protocol (IP) address, playing a role as both an identifier to identify a communication object and a locator to indicate the location of the communication object, is not allocated to an end host.

As shown in FIG. 1, the Internet communication environment according to an exemplary embodiment of the present invention includes a plurality of end hosts 100 and a plurality of end routers 200, ER_1, ER_2, . . . , ER_j, ER_k.

The plurality of end hosts 100 do not include location information, but include end host identifiers (IDs) (EID) EID_1, EID_2, . . . , EID_j, EID_k, which are used to identify corresponding communication objects.

The plurality of end routers 200 includes respective locators, each indicating the location of a communication object.

Each of the end routers 20 can manage more than one mobile host within its own service area. For example, the first end router ER_1 services two mobile hosts, respectively having the first host identifier EID_1 and the second host identifier EID_2, and includes a first locator LOC_1 to indicate its own location.

Further, each of the end routers 200 can map its own locator and more than one end host ID, and manages the mapping result. Here, the end router 200 maps the locator and the end host ID using an additional server, such as an external domain name server (DNS).

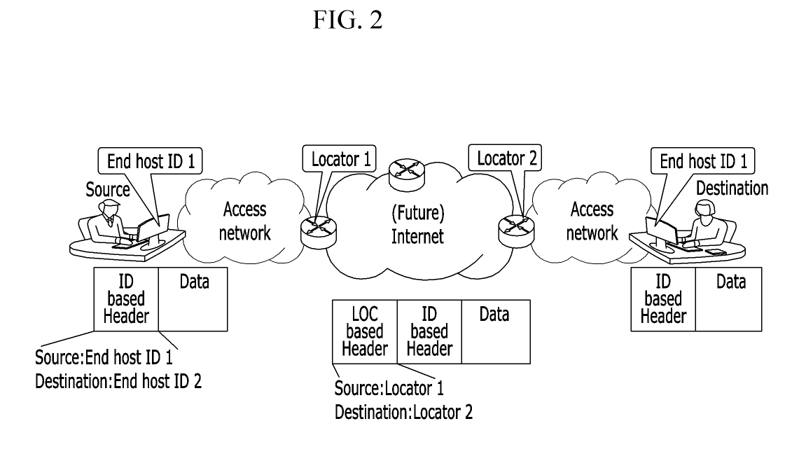

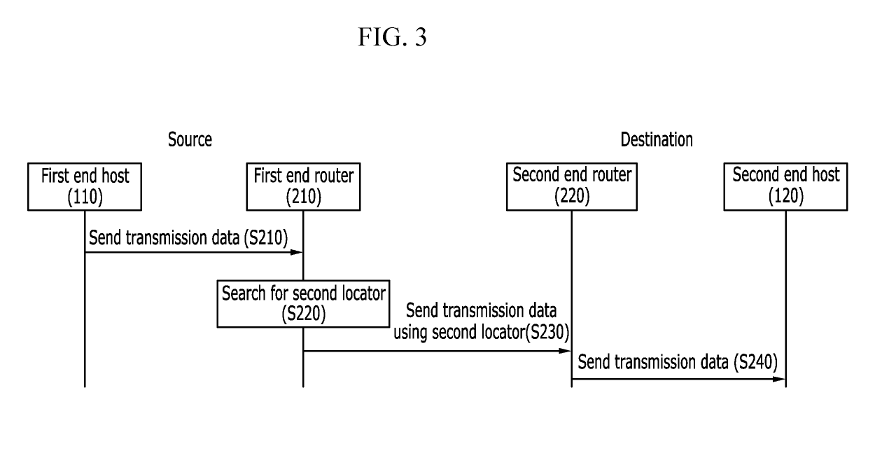

Hereinafter, a communication method between the end hosts on the basis of the identifier and locator structure is described in detail with reference to FIG. 2 and FIG. 3.

FIG. 2 is an example of showing a communication environment based on the identifier structure according to an exemplary embodiment of the present invention and FIG. 3 is a diagram showing a communication method based on the identifier structure according to an exemplary embodiment of the present invention.

First, an environment to which the communication method based on the identifier structure according to the exemplary embodiment of the present invention is applied includes a first end host 110 and a first end router 210 of a source and a second end host 120 and a second end router 220 of a destination. In FIG. 2, the first end router 210 knows the EID information of the first end host 110 through previous network attachment procedure.

As shown in FIG. 2 and FIG. 3, the first end host 110 sends transmission data to the corresponding first end router 210 at step S210. Here, the header of the transmission data includes the first end host ID End host ID 1 of the source and the second end host ID End host ID 2 of the destination.

For delivery from the first end host 110 to the first end router 210, local locator which is individually used in an access network can be used. For example, if the access network is WiFi or GPRS (general packet radio service), then local locator will be MAC address or GPRS tunnel ID, respectively. If the access network is IP network, then IP address is used as local locator. The first end router 210 has the mapping between the EID and the local locator for delivery in the access network. This may be applied to the delivery from the second end host 120 to the second end router 220. That is, the second end router 220 maps and manages the EID of the second end host 120 and the local locator in the access network which the second end host 120 access, and performs the delivery based on the mapped data.

The first end router 210 searches for the second locator Locator 2 of the second end router 220, corresponding to the second end host 120 of the destination, on the basis of the identifier included in the transmission data at step S220. Here, a method of searching for the location of an end router according to an exemplary embodiment of the present invention can be performed using an additional server, but is not limited thereto.

The first end router 210 transmits the transmission data to the second end router 220 on the basis of the retrieved second locator of the second end router 220 at step S230. Here, a method of transmitting the transmission data is performed using a datagram method, and may also be performed using a resource reservation method through previous signaling, such as a circuit method.

The end router of the source according to an exemplary embodiment of the present invention transmits the transmission data using a datagram method, such as a current Internet, and, to this end, additionally uses a header including the locator of the transmitting/receiving end router.

Next, the second end router 220 of the destination finally transmits the received transmission data to the second end host 120 of the destination at step S240.

Accordingly, the identifier and locator structure and the communication method based on the structure according to the exemplary embodiment of the present invention perform data transmission to a mobile host using only the locator of an end router and thus can efficiently support a mobile environment.

In accordance with exemplary embodiments of the present invention, an IP address (i.e., an identifier and a locator) is not directly allocated to an end mobile host constructed on a large scale, as in a current Internet, but only an identifier for maintaining communication connectivity with the mobile host itself is allocated to the mobile host rather than a network interface, and a locator for data transmission over a network is allocated only on the part of the network.

Accordingly, an efficient identifier and a locator structure can be provided to a mobile environment. Further, in a communication method based on the identifier and locator structure, data transmission for a mobile host within a network is performed using only the locator of an end router. Accordingly, a mobile environment can be supported more efficiently, as compared with a method of adopting a patch-on type in a structure based on a fixed environment, such as in the existing mobile IP.

Further, in accordance with the exemplary embodiments of the present invention, since a locator is not allocated to an end mobile host, the number of necessary locators can be greatly reduced. Further, since an identifier is allocated to a host itself, the problem of an identifier (or locator) increase resulting from multi-homing, etc., can be greatly mitigated.

Further, the identifier structure in which data transmitted to a destination end host do not include location information about a source host can solve the location privacy problem of a current Internet.

The exemplary embodiments of the present invention are not implemented only through the method and apparatus, but may be implemented through a program for realizing a function corresponding to a construction according to an exemplary embodiment of the present invention or a recording medium on which the program is recorded. The implementations will be evident to those having ordinary skill in the art to which the present invention pertains from the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A communication method between moving end hosts based on a structure in which only an identifier is allocated to the end host and a locator is allocated to an end router, the communication method comprising:
a first end router receiving transmission data from a source-side first end host;
the first end router searching for a locator of a second end router corresponding to a destination-side second end host on the basis of only an identifier included in the transmission data; and
the first end router sending the transmission data to the second end host via the second end router using the retrieved locator.

2. The communication method of claim 1, wherein the transmission data comprises an identifier of the first end host and an identifier of the second end host.

3. An identifier and locator structure, wherein only an identifier to identify a communication object is allocated to a mobile host, and a locator to indicate a location of the communication object is allocated to a corresponding end router.

4. The identifier and locator structure of claim 3, wherein the mobile host and the end router communicate with each other on the basis of the identifier.

5. The identifier and locator structure of claim 3, wherein a source-side end router and a designation-side end router communicate with each other on the basis of the locator.
